(19) United States
(12) Patent Application Publication
(10) Pub. No.: US 2007/0053389 A1
(43) Pub. Date: Mar. 8, 2007

(54) Method of manufacturing crystal oscillator

(76) Inventors: Toshihiro Sato, Saitama (JP); Hiroshi Uehara, Saitama (JP)

Correspondence Address: EDWARDS & ANGELL, LLP, P.O. BOX 55874, BOSTON, MA, 02205, US

(21) Appl. No.: 11/512,922

(22) Filed: Aug. 30, 2006

(30) Foreign Application Priority Data
Sep. 2, 2005 (JP) 2005-254870

(51) Int. Cl. H01S 3/10

(52) U.S. Cl. 372/22

(57) ABSTRACT

A method of manufacturing a crystal oscillator comprises: processing a crystal wafer, which has higher oscillation frequency inversely proportional to its thickness, into a thickness for a lower oscillation frequency than a reference oscillation frequency; measuring and storing the oscillation frequency of each area located lengthwise and crosswise of the crystal wafer, and subtracting the thickness of each area in turn depending on the difference in frequency of the oscillation frequency of each area and the reference oscillation frequency; and then obtaining a number of crystal pieces by dividing the crystal wafer into each area, wherein the crystal wafer is provided with dividing grooves in lengthwise and crosswise directions that section the crystal wafer into the individual areas. An object of the invention is to provide a method of manufacturing a crystal oscillator in which the thickness accuracy of each area of a crystal wafer is improved.

### BACKGROUND OF INVENTION

The present invention relates to a method of manufacturing a crystal oscillator comprising a step of leveling the thickness of a crystal wafer and a step of dividing it into a number of crystal pieces afterwards, particularly to a method of manufacturing a crystal oscillator in which the accuracy of the thickness of the respective crystal piece is improved.

A crystal oscillator is known as a frequency control device and is used as a reference source of a frequency or time by being embedded in oscillation circuits of various electrical equipment. Typically an AT-cut crystal which has a thickness-shear vibration mode, is mainly used as a crystal oscillator. In the AT-cut crystal the oscillation frequency inversely proportional to the thickness of a crystal wafer is higher. Recently, mass production of crystal oscillators of this type is desired, and attempts have been made to divide a crystal wafer into individual crystal pieces after leveling the thickness of the crystal wafer. One example has been disclosed by the applicant (Japanese Unexamined Patent Publication No. 2004-221816).

(Background Art)

FIG. 3 is drawings showing the method of manufacturing a crystal oscillator of a prior art, in which FIG. 3A is a top view, FIG. 3B is a sectional view of the crystal wafer when measured, and FIG. 3C is a sectional view of the crystal wafer when its thickness is controlled.

According to this method of manufacturing in the prior art, a crystal wafer 1 is firstly cut out by AT-cut from an artificial crystal (not shown) and shaped into a disk form or the like. This crystal wafer 1 has a diameter of, for example, 3 inches (76.2 mm). Secondly, the crystal wafer is ground by a grinding machine with a grinding plate into a particular thickness of lower oscillation frequency compared to the reference oscillation frequency (referred as “reference frequency” hereunder). That is, the crystal wafer is ground into a thickness that is thicker than the standard thickness. In this case, because the crystal wafer 1 has a large planar surface, or due to the irregular shape of a metal plate 4 on which the crystal wafer 1 is located, the crystal wafer 1 is not ground to an even thickness, and the center part of the main surface facing the grinding plate is shaped into, for example, a convex shape (as shown in FIG. 3B) or concave shape (not shown).

Next, the thickness distribution of the ground crystal wafer 1 is measured. The thickness distribution is measured on respective areas (refer to FIG. 3A) that are subsequently divided lengthwise and crosswise (shown as B-B and A-A directions) into the individual crystal pieces 2. For example, one main surface of the crystal wafer 1 is positioned on the metal plate 4, which functions as an electrode of an XY stage 3 as shown in FIG. 3B, and the other main surface is exposed to the air. The oscillation frequencies of the respective areas are then measured by a measuring device 6 with an electrode rod 5, which is coupled to the metal plate 4, being abutted against the exposed other main surface of the crystal wafer 1. As shown in FIG. 3A, addresses (1 to n) are given to the respective areas in the lengthwise and crosswise directions (shown as B-B and A-A directions), and a computer (not shown) that has a memory circuit is connected to the measuring device 6. The oscillation frequencies corresponding to the respective areas (1 to n) of the crystal wafer 1 are then stored in the memory circuit in turn depending on their addresses.

Next, based on the differences in frequency of the oscillation frequency of each area and the reference frequency, the amount of processing (process data) to give the reference frequency is set for each area (1 to n). As shown in FIG. 3C, an ion beam is irradiated from an ion gun 7 to each area on the crystal wafer 1 fixed on the XY stage 3 in turn, and the other main surface of the crystal wafer 1 is cut to an atomic level. In this case, the irradiation time of the ion beam P is set based on the process data (the amount of process) of each area. Accordingly, the crystal wafer 1 is processed so that its thickness is equal to or less than the prescribed thickness that is within the reference frequency. Finally, a vibration electrode and an extraction electrode are formed on each crystal piece 2 which is subsequently separated from the crystal wafer 1 by etching using a printing technique. The crystal wafer 1 is then cut lengthwise and crosswise (shown as B-B and A-A directions) and divided into individual crystal pieces 2.

(Problems to be Solved by the Invention)

However, according to the aforementioned conventional method of manufacturing a crystal oscillator, the oscillation frequencies are measured on each area (1 to n) of the crystal wafer 1 where the thickness varies depending on the area. Therefore, there is a problem in that measuring an oscillation frequency of high accuracy is difficult due to the effect of the thicknesses of an adjacent area, that is, the acoustic coupling of both the areas. In this case, the oscillation frequency of the crystal piece 2 measured after each area being divided is different from the ones measured before the dividing. For example, when the thickness of adjacent areas are high, measured oscillation frequency is lower than actual. Moreover when the thickness of adjacent areas are low, measured oscillation frequency is higher than actual.

After keeping the crystal pieces 2 in a container (not shown), the oscillation frequencies of the crystal pieces 2 are finally fine-tuned by increasing and decreasing the thicknesses of the excitation electrode or the like, or by a so-called mass loading effect. However, because there is a limitation to the amount of the adjustment of the oscillation frequency, a crystal piece 2 that is not within the thickness of the predetermined oscillation frequency can not be fine-tuned, and becomes a defective product. Therefore, controlling the thickness of the crystal piece 2 to within the prescribed thickness is extremely important under the current situation that requires strict standards.

(Object of the Invention)

It is an object of the present invention to provide a method of manufacturing a crystal oscillator in which the thickness accuracy of each area of a crystal wafer is improved.

### SUMMARY OF INVENTION

According to the present invention, a method of manufacturing a crystal oscillator comprises: processing a crystal wafer, which has higher oscillation frequency inversely proportional to its thickness, into a thickness that has a lower oscillation frequency than a reference oscillation frequency; measuring and storing the oscillation frequency of each area located lengthwise and crosswise of the crystal wafer, and subtracting the thickness of each area in turn depending on the difference in frequency of the oscillation frequency of each area and the reference oscillation frequency; and then obtaining a number of crystal pieces by dividing the crystal wafer into each area, wherein the crystal wafer is provided with dividing grooves in lengthwise and crosswise directions that section the crystal wafer into the individual areas.

According to this configuration, because the dividing grooves are provided for each of the areas of the crystal wafer, when the oscillation frequencies are measured, each measurement of the area can be executed independently without being affected by the acoustic coupling of adjacent areas. Therefore, based on this measurement, the crystal wafer can be processed to give a prescribed oscillation frequency, that is, a prescribed thickness, and hence irregularity of thickness can be reduced, and defective products prevented.

According to the present invention, each area sectioned by the dividing grooves corresponds to one individual crystal piece. Therefore, the oscillation frequencies of the crystal pieces can be individually controlled, and the accuracy of the frequency of the crystal pieces can be improved.

Also, according to the present invention, each area sectioned by the dividing grooves corresponds to a plurality of crystal pieces and the crystal pieces have the dividing groove therebetween. According to the present invention, for example, when the accuracy of grinding the crystal wafer is high or the standard of frequency precision is lenient, the productivity of the crystal pieces can be improved because the thicknesses of a plurality of crystal pieces can be controlled integrally.

Moreover, according to the present invention, the dividing grooves of at least one direction of the lengthwise and crosswise directions is V shaped. According to this, because inclined planes are formed at the both ends (outer peripheral faces) of a crystal piece after dividing, it is not necessary to bevel additionally, which has an effect to hold vibration energy when the crystal oscillator is sealed in a package. Therefore it is possible to shorten the time to manufacture a crystal wafer and to improve productivity.

### BRIEF DESCRIPTION OF THE DRAWINGS

FIG. 1 is explanatory drawings showing one embodiment of a method of manufacturing a crystal oscillator according to the present invention, in which FIG. 1A is a local sectional view towards the center of a crystal wafer, FIG. 1B is a sectional view of the crystal wafer when being measured, FIG. 1C is a sectional view of the crystal wafer when its thickness is being controlled, FIG. 1D is a sectional view of a U shaped groove, and FIG. 1E is a sectional view of a rectangular groove. The convex shape of the other main surface of the crystal piece is illustrated exaggeratedly.

FIG. 2 is a perspective view of the crystal piece processed by a method of manufacturing a crystal oscillator according to one embodiment of the present invention.

FIGS. 3 are drawings showing a conventional method of manufacturing a crystal oscillator, in which FIG. 3A is a top view of a crystal wafer, FIG. 3B is a sectional view of the crystal wafer when being measured, and FIG. 3C is a sectional view of the crystal wafer when its thickness is being controlled.

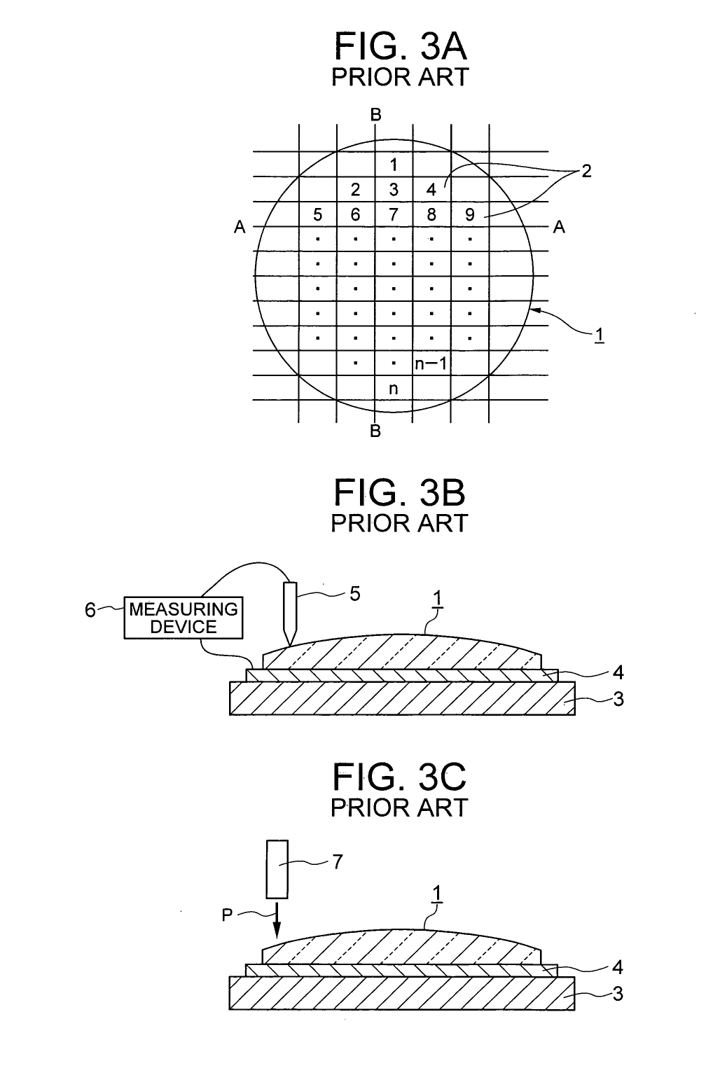

### DETAILED DESCRIPTION OF THE PREFERRED EMBODIMENT

### Embodiment

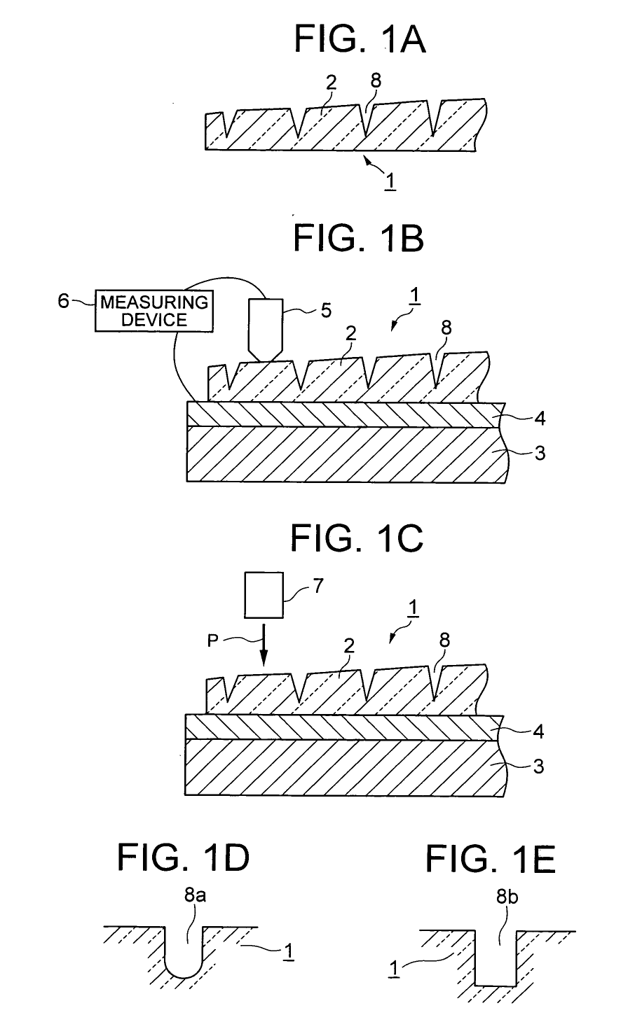

FIG. 1 are explanatory drawings showing one embodiment of a method of manufacturing a crystal oscillator according to the present invention, in which FIG. 1A is a local sectional view towards the center of a crystal wafer, FIG. 1B is a sectional view of the crystal wafer when being measured, and FIG. 1C is a sectional view of the crystal wafer when its thickness is being controlled.

According to the method of manufacturing a crystal oscillator of the present invention, as with the conventional method, a disk formed piece is cut out from an artificial crystal by AT-cut and ground into a crystal wafer 1 that is thicker than for the reference frequency. In this case, for example, the center part of the crystal wafer 1 is ground into a convex shape. Next, the crystal wafer 1 is sectioned into areas, which are respectively separated into crystal pieces 2 later on, by providing one main surface of the crystal wafer 1 with dividing grooves 8 in the lengthwise and crosswise directions. That is, each area corresponds to an individual crystal piece 2 when divided. The dividing grooves 8 have a V shaped section that is formed, for example, according to the V shaped blade edge of a dicing blade. In this embodiment, the depth of the dividing grooves 8 is greater or equal to half of the thickness of the crystal wafer 1 (refer to FIG. 1A).

Next, thickness distributions depending on the respective areas of the crystal wafer 1 are measured by a measuring device 6 with an electrode rod 5, which is coupled to a metal plate 4, being abutted against one main surface of the crystal wafer 1. For example, the other main surface of the crystal wafer 1 is located on the metal plate 4 as an electrode of an XY stage 3, and the one main surface on which the dividing grooves 8 are provided in the lengthwise and crosswise directions is exposed. Then, the electrode rod 5, which is connected to the measuring device 6, is abutted against each area in the lengthwise and crosswise directions to which an address (1 to n) is given by a computer, and the oscillation frequency of each area is individually measured and stored in the memory circuit in turn (refer to FIG. 1B).

Moreover, after the amount of the process (process data) is set based on the frequency difference between the oscillation frequency of each area of the crystal wafer 1 and the reference frequency, the crystal wafer 1 is processed into the prescribed thickness that is for the reference frequency, by irradiating an ion beam P from an ion gun 7 to each area in turn for a predetermined time. Finally, a vibration electrode and an extraction electrode are formed on each crystal piece 2 by etching using a printing technique.

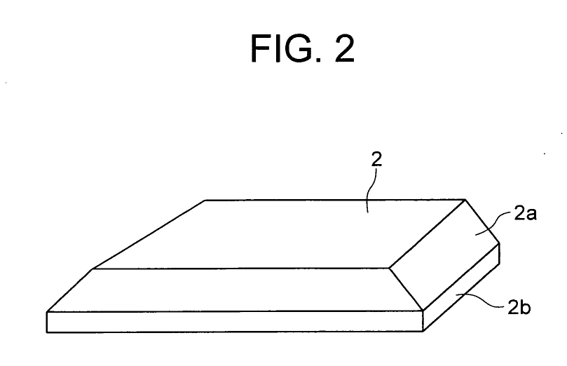

Then, a number of crystal pieces 2 are obtained by cutting at the distal side of the V shaped dividing grooves 8 provided in the lengthwise and crosswise directions of the crystal wafer 1 by a dicing blade or the like that has a narrow blade width (refer to FIG. 2). To this end, inclined planes (bevels) 2a are formed on the outer peripheral portion of the crystal piece 2, and the outermost sides of these become end faces 2b when cutting.

According to the aforementioned method of manufacturing of the present invention, the acoustic coupling between each area is prevented by the dividing grooves 8 provided respectively to each area of the crystal wafer 1. In this embodiment, because the depth of the dividing groove 8 is greater or equal to half of the thickness, half or more of the vibration mode generated vertically vanishes, improving the effect of prevention of acoustic coupling. Therefore, when measuring the oscillation frequencies, each area of the crystal wafer 1 can be independently measured without being affected by adjacent areas. Therefore, each area of the crystal wafer 1 can be processed to within the prescribed thickness for the reference frequency, and hence irregularity can be reduced, and defective products prevented.

Also, according to the method of manufacturing of the present invention, because the dividing grooves 8 are V shaped and their distal sides are cut by a dicing blade having a narrow blade, the crystal pieces 2 corresponding to respective areas have bevel faces 2a. Therefore, as described in Japanese Unexamined Patent Publication No. 2004-96526, because it is not necessary to bevel additionally using a cylinder or the like, it is possible to shorten the manufacturing steps (time) even if barrel grinding to remove ridge line portions of the crystal piece 2 is executed. In this embodiment, all of the peripheries are beveled, however for example at least the sides of both ends of the extraction electrode extended in X axis direction may be formed into bevel faces 2a.

### Another Embodiment

Although the oscillation frequencies are respectively measured on each area corresponding to each crystal piece 2 of each crystal wafer 1 in the aforementioned embodiment, when the grinding accuracy is satisfactory or the standard is lenient, or the like, for example, by assuming a group of adjacent four crystal pieces 2 sectioned by the dividing grooves 8 to be one area, an oscillation frequency of only one crystal piece 2 out of four in each area is measured.

Then, by assuming the frequency to be that of every area, an ion beam may be irradiated to each area of the crystal piece 2 to control. Namely, in this embodiment, each area of the crystal wafer 1 comprises a plurality of crystal pieces 2. In this case, it is possible to improve productivity, as the time to measure the oscillation frequency can be shortened. An ion beam can also be irradiated to the four crystal pieces 2 simultaneously to control, and the productivity can be further improved.

Although the dividing grooves 8 of the crystal wafer 1 have V shaped sections, different cross-sectional shapes (such as the U shaped groove 8a shown in FIG. 1B or the rectangular groove 8b shown in FIG. 1E) may be adopted including the case where a beveled face is not necessary because the oscillation frequency is high enough. Moreover, although cutting the thickness of the crystal wafer 1 is processed by irradiating an ion beam, cutting may also be processed by sputtering or the like. Furthermore, although the center part of the other main surface of the crystal wafer 1 is convex or concave shaped, the shape is of course not limited to this.

Moreover, although the crystal wafer 1 is divided into individual crystal pieces 2 after the vibration electrode and the extraction electrode are formed on each area, the vibration electrode and the extraction electrode may be formed on each crystal piece 2 after the respective crystal pieces 2 are separated. Furthermore, although the crystal wafer 1 is cut by an AT cut, any thickness-shear vibration mode such as a SC cut can be adopted.

What is claimed is:

1. A method of manufacturing a crystal oscillator comprising the steps of:
processing a crystal wafer, which has higher oscillation frequency inversely proportional to its thickness, into a thickness that has a lower oscillation frequency than a reference oscillation frequency;
measuring the oscillation frequency of each area located lengthwise and crosswise of said crystal wafer and storing in a memory circuit, and subtracting the thickness of each area in turn depending on the difference in frequency of the oscillation frequency of said each area and said reference oscillation frequency; and then
obtaining a number of crystal pieces by dividing said crystal wafer into each area,
wherein said crystal wafer is provided with dividing grooves in lengthwise and crosswise directions that section the crystal wafer into said individual areas.

2. A method of manufacturing a crystal oscillator according to claim 1, wherein each area sectioned by said dividing grooves corresponds to the shape of one individual crystal piece.

3. A method of manufacturing a crystal oscillator according to claim 1, wherein each area sectioned by said dividing grooves corresponds to the shape of a plurality of crystal pieces and said plurality of crystal pieces have said dividing groove therebetween.

4. A method of manufacturing a crystal oscillator according to claim 1, wherein the dividing grooves of at least one direction of the lengthwise and crosswise directions is V shaped.

5. A method of manufacturing a crystal oscillator according to claim 1, wherein the dividing grooves of at least one direction of the lengthwise and crosswise directions is U shaped.

6. A method of manufacturing a crystal oscillator according to claim 1, wherein the dividing grooves of at least one direction of the lengthwise and crosswise directions is a rectangular cross-section.
